(19) United States
(12) Patent Application Publication
(10) Pub. No.: US 2007/0179828 A1
(43) Pub. Date: Aug. 2, 2007

(54) Method and system for top-down business process definition and execution

(76) Inventors: Alex Elkin, Boxborough, MA (US); Scott Opitz, Media, PA (US)

Correspondence Address: MORRISON & FOERSTER LLP, 1650 TYSONS BOULEVARD, SUITE 400, MCLEAN, VA, 22102, US

(21) Appl. No.: 11/730,506

(22) Filed: Apr. 2, 2007

Related U.S. Application Data
(63) Continuation of application No. 09/811,564, filed on Mar. 20, 2001, now abandoned.
(60) Provisional application No. 60/191,166, filed on Mar. 22, 2000.

(51) Int. Cl. G05B 19/418

(52) U.S. Cl. 705/8; 705/1

(57) ABSTRACT

A system and method is presented utilizing a set of software tools for the graphical definition of top-down workflow process models. Once defined, these models are completely useable enterprise applications that can be deployed in real-time without interrupting current business operations. The present invention has three main components: the process designer, the process server, and the process clients. The process designer allows users to define the business processes from the top down without programming. The process definitions are made up of components, such as tasks and subprocesses. Tasks are work items that are performed either by a human or automatically by an existing system. Tasks in the present invention incorporate all GUI panels necessary for an end-user to complete the task. Events link the process components together, defining control flow and providing a means for data flow through the process model. Process models also include roles, end-users, business logic, and other components that allow parallel processing, synchronization, and timing of services. Adapters allow business data and logic external to the present invention to be incorporated into the process model. The process model definitions are then installed on the process server, which presents the tasks to end-users. End-users access and perform tasks through the process clients.

This application claims the benefit of provisional patent application U.S. Ser. No. 60/191,166, filed Mar. 20, 2000.

### TECHNICAL FIELD

The present invention relates to a method and computer system for top-down definition and implementation of business processes.

### BACKGROUND OF THE INVENTION

The present invention allows one software application to coordinate the process of an entire business by defining and implementing business processes from the top-down. Business processes are, quite simply, the processes a business must execute in order for the business to operate. For example, a corporation that is in the business of selling products must be able to receive orders for those products. The entire act of receiving orders and shipping products can be considered a business process. On a smaller scale, the entry of a phone order into a corporate database is also a business process.

The top-down approach to analyzing business processes means that the processes are defined beginning at the highest level of an enterprise. An analyst using this approach might start with the process of selling products. The process of selling products can be broken down into smaller subprocesses, such as receiving customer orders and shipping products in response to customer orders. Each of these further subprocesses can be further reduced, until every employee's tasks are set forth in the business process model.

The concept of defining business processes from the top down is not new. Graphical software tools exist in the prior art to assist in the creation of top-down business process models. The end result of using these prior art tools is a detailed, top-down definition of the processes of the business. Executives and analysts find such detailed definitions useful, as waste, inefficiencies, and duplication become clear once the processes of the business are explicitly defined in this manner. The tools then allow the business processes to be redefined and streamlined, and hopefully the business can become more profitable as it adopts the new top-down business processes.

Unfortunately, the newly defined business processes must then be implemented in the real world. As any executive knows, implementing a new process that exists only on paper is never easy. First, the description of the business process is generally given to computer software developers who then attempt to implement it to the best of their understanding. The result almost never exactly matches the process that the business analyst developed. This is an inherent result of the fact that the business analyst is not able to develop the software directly, but must instead rely on software programmers to implement the defined process.

Another difficult issue to overcome is the coordination of computer resources necessary to implement even a single business process. In every large business, numerous incompatible computing platforms, operating systems, networking protocols, databases, and custom applications coexist. Since it is impossible to wish away such incompatibilities, the various environments must be integrated in order to implement a new business process.

In recent years, many businesses have turned to Message-Oriented-Middleware (MOM) products to aid in the integration of disparate computing systems. Typically, such middleware products provide interfaces to applications by capturing, analyzing, and exchanging information via “business events.” This mechanism allows business analysts to integrate many diverse application platforms to work together.

Unfortunately, while middleware products allow business applications to communicate together, they do not ease the task of automating new business processes. Middleware products do not allow for the reuse of business structure or business knowledge between applications. Instead, when such a business structure or knowledge must be reused, a new application must be created from scratch.

While middleware solutions cannot help when structures or knowledge must be reused, many businesses have turned to object-oriented development environments to meet this need. Since reusability is an important element in the object-oriented paradigm, this approach should allow new applications to be developed by reusing objects created in earlier applications. Unfortunately, because of the technical nature of object creation, definition, and refinement, many of reusability advantages of the object-oriented paradigm are inaccessible to the typical business process analyst.

Because of these difficulties, implementing a newly designed, top-down business process is almost always a time-consuming, drawn out event. In fact, the effort and time involved in implementing a new business process is so significant that new processes are often revised or even scrapped before complete implementation of the process is ever achieved.

What is needed is the ability to define and implement top-down business process models in a single step, where the actual definition of the business model, created and owned by the business people and not software programmers, results in executable software that implements the defined business model. What is further needed is the ability to integrate the newly defined business models with existing enterprise applications, either by taking advantage of existing middleware interfaces or by using interfaces that link directly to corporate applications and databases. The desired application must have the ability to create easily reusable objects at a high level of abstraction, allowing the objects to be useful across the enterprise without complete redefinition for each use. Finally, what is also needed is a process server that deploys predefined processes and assigns tasks for completion by employees or existing applications in the organization.

### SUMMARY OF THE INVENTION

The present invention meets these goals by incorporating a set of software tools that allow the graphical definition of top-down workflow process models. Once defined, these models are completely useable enterprise applications that can be deployed in real-time without interrupting current business operations.

Business processes are defined in the present invention using a graphically interface that does not require programming. The components of a process model are presented visually to a designer, who can link components together to create work flow and business logic. The business work flow can be defined down to the level of a business task, which is a unit of work that is to be accomplished by an individual or an existing business program. In fact, the task itself is fully defined in the present invention, including the user interface presented to the end-user for completion of the task. The interfaces can be developed for use with multiple hardware components, allowing a task to be completed through a Java run-time application, a web browser, or even a PDA interface such as the Palm OS by Palm, Inc. (Santa Clara, Calif.).

The present invention has three main components: the process designer, the process server, and the process clients. The process designer allows users to define the business processes from the top down. The process definitions are made up of components, such as tasks and subprocesses. Tasks are work items that are performed either by a human or automatically by the existing systems. Process models also include roles, end-users, business logic, and other components that allow parallel processing, synchronization, and timing of services. Business data is obtained from databases as well as from existing enterprise applications.

Completed enterprise process definitions are deployed to and executed in the process server. Users log into the process server and the process server then presents them with their task assignments. Along with their assignments, users are also presented the business data necessary to accomplish their task and, if necessary, with the GUI interface required to execute the task. The process server prioritizes workflow, and provides management interfaces for task queue monitoring.

The process client is a GUI based application, a web browser, or even a PDA interface that allows end-users to log on and connect to the process server(s), to access the task lists, and to perform the tasks assigned to them. The end-users automatically get access to the necessary information and resources needed to complete the assigned task.

### BRIEF DESCRIPTION OF THE DRAWINGS

FIG. 1 is a representational view of two processes as might be defined in the present invention.

FIG. 2 is a representational view showing data mapping in the present invention through a process having a subprocess, the subprocess in turn having a task.

FIG. 3 is an organizational chart showing the hierarchy of elements in a process model of the present invention.

FIG. 4 is a chart showing the hierarchy rules for the allowed components in each container in the present invention.

FIG. 5 is a chart showing the default actions, results and properties of containers in the present invention.

FIG. 6 is a chart showing the default actions, results and properties of elements in the present invention.

FIG. 7 is a representational view showing flow control of a join element in the present invention.

FIG. 8 is a representational view showing flow control of a timer element in the present invention.

FIG. 9 is a representational view showing flow control of a comparator element in the definition of a router in the present invention.

FIG. 10 is a representational view of the software tools in the present invention.

FIG. 11 is a representational view of the repository in the present invention.

FIG. 12 is a GUI operating system window showing a project management interface in the present invention.

FIG. 13 is a GUI operating system window showing the user interface of the project designer in the present invention.

FIG. 14 is the user interface of FIG. 13 operating in control flow editor mode.

FIG. 15 is the user interface of FIG. 14 with the sub-process 122 selected.

FIG. 16 is a flow chart showing the process of combining elements in control flow and data flow in the present invention.

FIG. 17 is a GUI operating system window showing a new link dialog box in the present invention.

FIG. 18 is a GUI operating system window showing an event mapping dialog box in the present invention.

FIG. 19 is the user interface of FIG. 13 operating in task editor mode.

FIG. 20 is a flow chart showing the process of defining a view in the present invention.

FIG. 21 is a GUI operating system window showing a task list for presentation to an end-user in the present invention.

### DETAILED DESCRIPTION OF THE INVENTION

Process Model 100

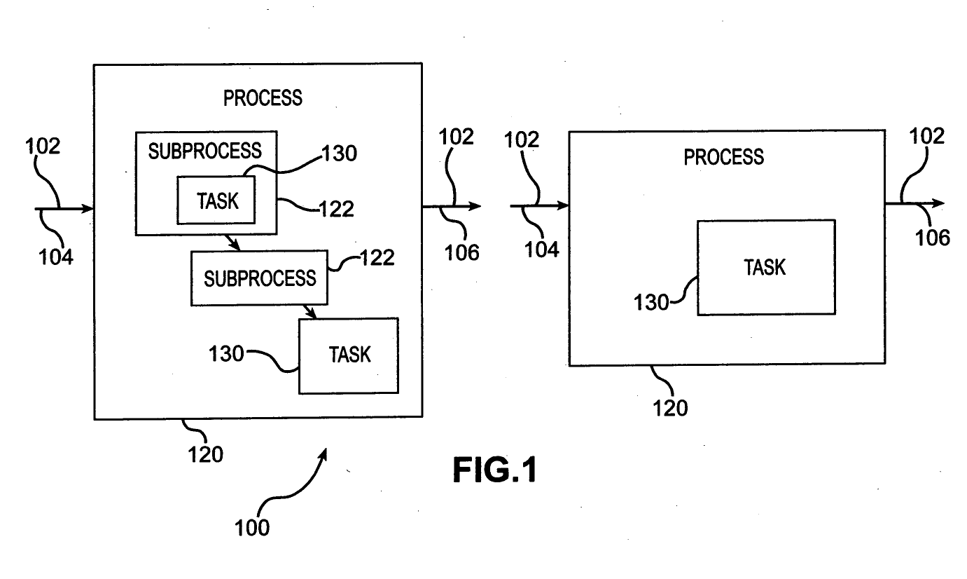

As shown in FIG. 1, a process model 100 is a representation or model of the business activities that exist in a corporation, division, or some other type of entity or business unit. Each process model 100 will contain one or more processes 120, each of which represent a specific real-world business activity. Example processes 120 include “accepting purchase orders” and “paying an invoice.”

Each process 120 may include one or more subprocesses 122 or one or more tasks 130. A task 130 is typically a unit of work that is performed by a person or an automated computer program as a step within a process 120. Entering a purchase order on a computer terminal and sending a check to be printed to a printer are example tasks 130. Enclosing subprocess 122 within process 120 indicates that the subprocess 122 must be completed before the enclosing process 120 can be deemed complete. A single process 120 can contain multiple subprocesses 122, but may directly contain only a single task 130.

In the present invention, a subprocess 122 is considered a “component” of the process 120 that contains it since it makes up part of that process 120. The process 120 is itself considered a “container” since it contains one or more components. The process 120 is also considered a component, since it could itself be contained in a larger container.

Each process 120 is triggered by an event 102. For example, the triggering event 102 for an “accepting purchase order” process 120 may be the receipt of a purchase order. In addition to being triggered by an event 102, each process 120 also creates a new event 102 when the process 120 is completed. For instance, the new event 102 after the accept purchase order process 120 might be called “purchase order accepted.” Events 102 that trigger a process 120 are called actions 104. Events 102 that are created by a completed process 120 are called results 106. When a real world event occurs, it will typically be represented as a result 106 of a first process 120 and an action 104 of another process 120. Although only a single action 104 and result 106 is shown for each process 120 in FIG. 1, it is possible for a component to have multiple actions 104 and results 106.

There are two important steps to creating a complete process model 100. First, the control flow of the process model 100 must be created. The control flow describes the sequence of processes 120 and tasks 130 in an enterprise. A user creates control flow model by taking known processes 120 and connecting the result(s) 106 of one process 120 to the action(s) 104 of another process 120.

The linking of processes 120 through events 102 does not in itself create a complete process model 100. This is because business data also flows through an enterprise. A model 100 that shows processes and events without showing the movement of business data is incomplete. For instance, a “handle claim” process 120 that results in a “claim handled” result 106 is meaningless without information about whose claim was handled. Thus, a process model 100 must contain both control flow and data flow. Since the process model 100 shown in FIG. 1 shows only control flow and not data flow, it is not a complete representation of a process model 100.

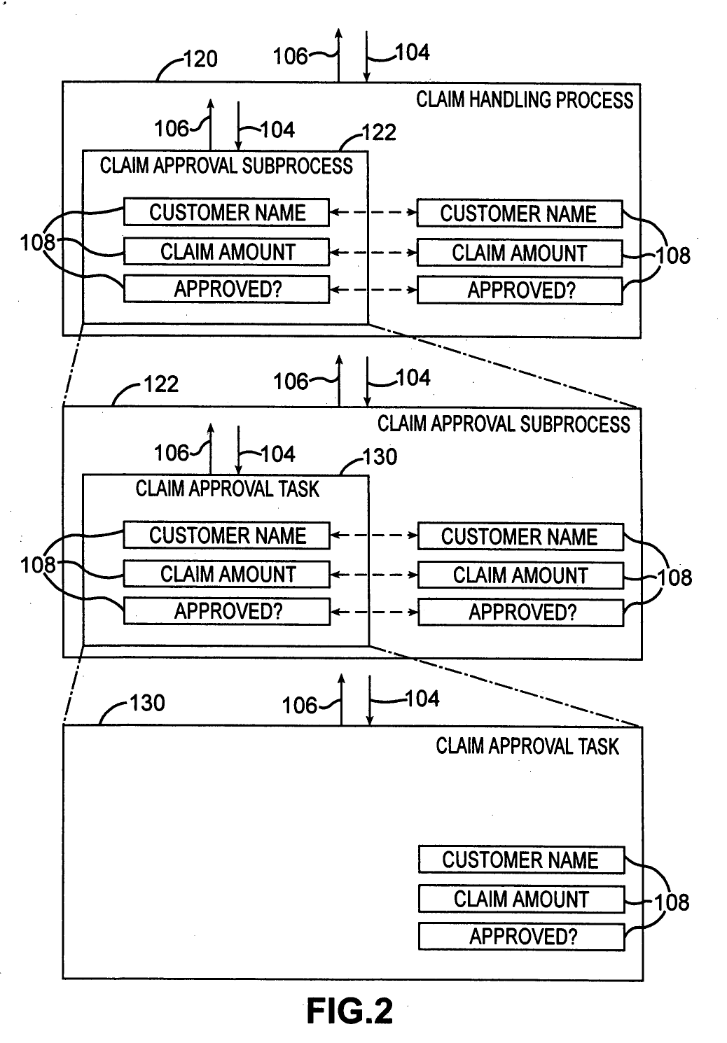

The conceptual diagram of FIG. 2 shows a more complete process model 100. This figure shows claim handling process 120. Located within the claim handling process 120 is the claim approval subprocess 122, which in turn consists of a single obtain approval task 130. The claim handling process 120, the claim approval subprocess 122, and the obtain approval task 130 each have one action 104 and one result 106. An example of an action 104 that would trigger the claim handling process 120 would be a “receive claim” action 104. When the claim handling process 120 is complete, the process 120 will provide result 106 to the rest of the control flow model 100 such as “claim approved” or “claim denied.” This result 106 may then trigger further processes 120.

In order to determine whether the claim should be approved or denied, the person performing the obtain approval task 130 will need to review specific data related to the claim. In the present invention, this type of data is stored in variables or attributes 108 within claim handling process 120. Three attributes 108 are shown in FIG. 2, namely the customer name, the claim amount, and the approval status of the claim. The claim handling process 120 could have many more attributes 108, such as customer address and phone number, customer ID, reason for the claim, product serial number, and so on. The attributes 108 shown in FIG. 2 are for example purposes, and would not be sufficient for an actual implementation. Similar attributes 108 are shown in the claim approval subprocess 122 and the obtain approval task 130.

The purpose of data mapping in the present invention is to allow data to move from the attributes 108 of one component to the attributes 108 of the next component as the control flow is executed. A container can both pass data into and receive data from a contained component by mapping the attributes 108 of the container to attributes 108 of the component. For example, the customer name and claim amount attributes 108 of claim handling process 120 are mapped to the attributes 108 of claim approval subprocess 122, as shown by the dotted lines. In this manner, the value of the customer name and claim amount attributes 108 in the claim handling process 120 are transferred to the similarly named attributes 108 in the claim approval subprocess 122.

Similarly, subprocess 122 transfers these values to the attributes of the contained obtain approval task 130. When the obtain approval task 130 is completed, the “Approved?” attribute 108 will have a value that is assigned during the completion of the task 130. This value is then mapped back to the “Approved?” attribute 108 of subprocess 122 through data mapping, which associates the attribute values of containers with the attributes 108 of components. Finally, the “Approved?” attribute value gets mapped to the appropriate attribute 108 in the claim handling process 120.

Components 110

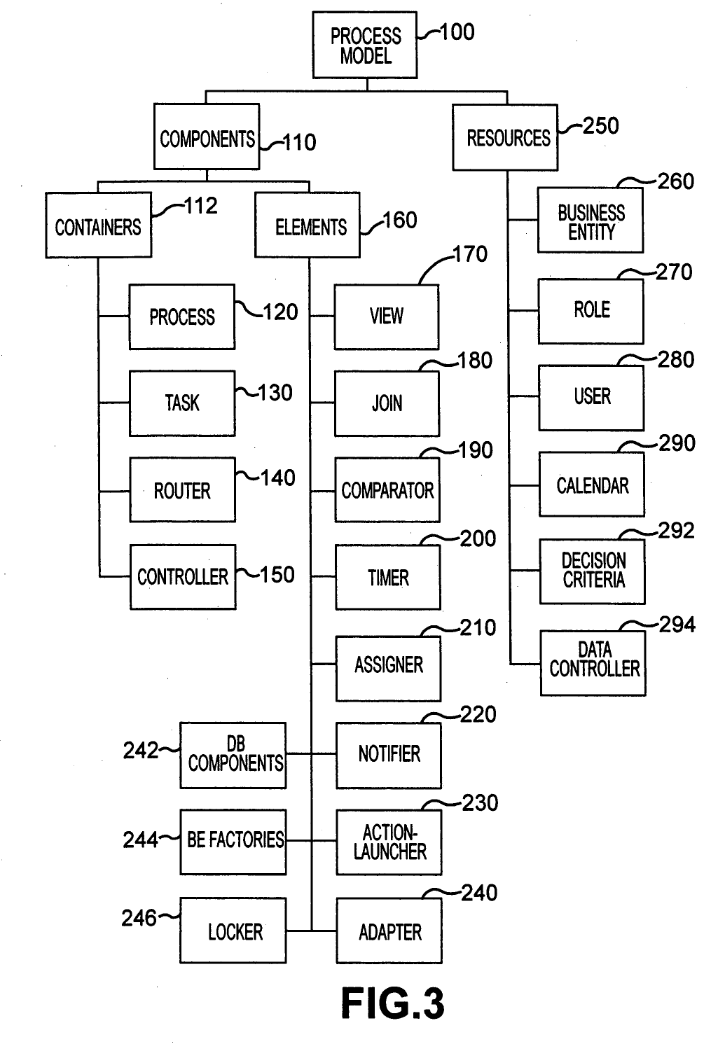

In order to create a process model 100, the present invention uses a defined set of building blocks. These building blocks can be divided between components 110 and resources 250, as shown in FIG. 3. Components 110 are the basic building blocks used to graphically build control flow of process models 100. Resources 250 are place holders of enterprise business data and support the modeling of information flow in the process models 100.

All components 110 have basic properties 109 associated with them, including actions 104, results 106, and attributes 108. As explained above, actions 104 and results 106 are business events 102 used in both control flow and information flow. Attributes 108 are used to store business information useful to the component 110. Like components 110 themselves, events 102 also have attributes 108 to move data from one component 110 to another.

Some components, namely processes 120, tasks 130, and controllers 150, can be used in multiple locations in a process model at the same time. This is allowed because a properly designed purchase order process 120 should require very little or no change if used in different areas of an enterprise. If changes are needed to accommodate any variations in a reusable component 110 (such as changes due to sales tax or similar local laws), the component 110 can be duplicated and the changes can be made to the newly created component 110. This same technique of creating a copy of a component 110 can be used for components 110 that are not considered reusable as well. In making a duplicate, the components 110 are not reused since a new instance of the component 110 is created for each use.

In addition to actions 104, results 106, and attributes 108, components 110 will also have additional properties 109 such as the component's name and description. There are two types of properties 109, global properties, and context sensitive properties. Global properties apply to all instances of a component 110 regardless of where the component 110 is used. For example, the name and the description of a process 120 are both global properties. As a result, changing the name results in the name being changed everywhere the process 120 is used. Context sensitive properties vary between individual iterations of components 110, and hence are used only by reusable components 110. For example, a particular task 130 that is used multiple times may have differing priorities at each iteration. Consequently, priority would be a context sensitive property. Attributes 108 are context sensitive as well.

Containers 112

As shown in FIG. 3, there are two main types of components 110, namely containers 112 and elements 160. Containers 112 are those types of components 110 that can contain other components 110. The present invention utilizes four containers: processes 120, tasks 130, routers 140, and controllers 150. Elements 160 are those portions of a process model definition that do not contain other components 110.

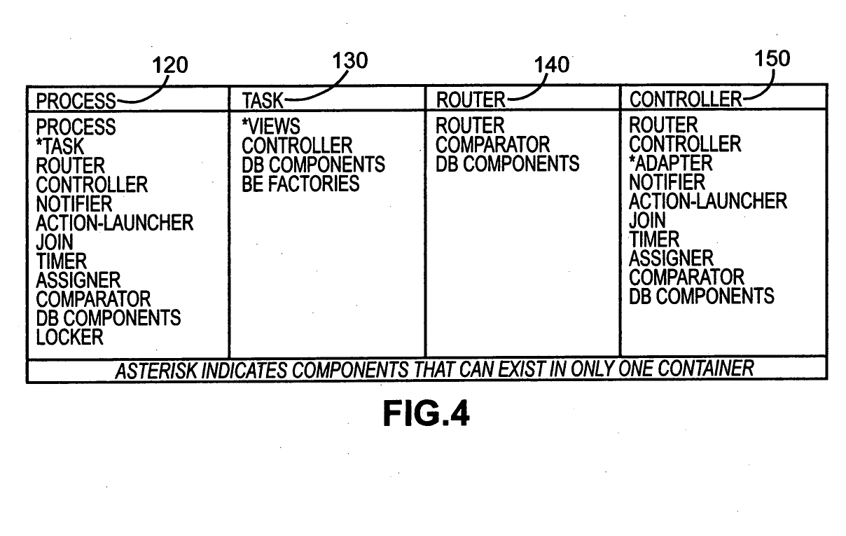

While containers 112 by definition can contain other components 110, they cannot contain every type of component 110. The table in FIG. 4 shows the valid components 110 for each type of container 112. As noted in FIG. 4, some containers 112 support the existence of only one contained component 110 of a particular type. For instance, each process 120 is allowed to contain only one task 130. This particular limit can be worked around since a process 120 can utilize multiple subprocesses 122 that each contain a separate task 130. FIG. 4 indicates which components can only occur singularly within a container by listing the exclusive component 110 with an asterisk.

Process 120

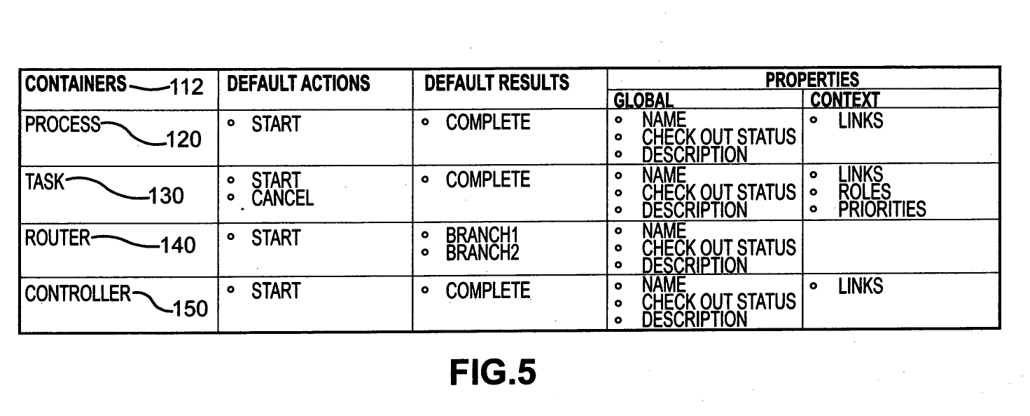

As explained above, a process 120 is a set of one or more subprocesses 122, tasks 130, or other component 110 that together achieve a specific business activity. The default actions 104, results 106, and other properties 109 for processes 120 and other containers 110 are shown in the chart of FIG. 5. The chart in FIG. 5 divides the properties 109 for each container 112 into global and context properties. As shown in this chart, the sole default actions 104 for processes 120 is start. This action obviously is the generic action 104 that starts the process 120 operating. This action 104 will usually have its name altered to more accurately reflect its business purpose. A common second action might be a cancel action 104. If the cancel action is triggered, a previously started process will be cancelled.

FIG. 5 also shows that the single default result 106 for a process 120 is “complete.” This result 106 obviously indicates to the rest of the process model 100 that the process 120 has completed. Again, this result 106 will usually be renamed. Multiple results 106 could be utilized to indicate different results from the process 120. For instance, one result 106 could indicate claim approval, and a second result 106 could indicate claim rejection.

The global properties 109 of a process 120 are name, check out status, and description. The process 120 can be identified in the construction of a process model 100 through its name. The description property 109 contains a description of the defined process 120. Although each process 120 is partially self-documenting merely by utilizing a graphical means of definition (see below), embedding a description into a property 109 of the process 120 itself makes the process 120 even more self-documenting.

The check out status property 109 is used during development to determine whether the process 120 is currently checked out to a developer.

The sole contextual property 109 for processes 120 is the links property. The links property keeps track of all the other components 110 to which the particular instance of the process 120 is connected.

In addition to properties 109, default actions 104 and results 106, each process 120 will also have attributes 108, customized events 102, and contained, linked components 10 that help define and differentiate that process 120 from all other processes 120. The steps through which these elements of a process 120 are defined are explained below.

Task 130

As explained above, each task 130 contains a work assignment to an individual or program to complete a specific task. In addition to a simple assignment of work, each task 130 also embodies all the business logic and business data that is needed to actually accomplish the assigned work elements. For example, if a task 130 is assigned to an end-user to approve an insurance claim, the task 130 would i) incorporate the needed business data needed for the end-user to approve that claim, ii) provide the business logic to be used to approve the claim, and iii) present this information to the end-user in a customized GUI interface. The process for incorporating all this information in the interface is described below in connection with the description of the task editor.

Tasks 130 contain two default actions 104 (start and cancel) and one default result 106 (complete), as is shown in FIG. 5. Tasks 130 also contain three of the same global properties 109 as processes 120, namely the name, check out status, and description properties. The form and function of the default actions 104, results 106, and global properties 109 are described above in the description of processes 120. The fact that tasks 130 do not share the property 109 initiate ad hoc indicates that the present invention does not allow tasks 130 to be initiated ad hoc. Although a decision was made in the preferred embodiment to require tasks 130 to be incorporated into processes 120 before being initiated ad hoc, this decision could have been made differently and this should not be taken as a limitation on the scope of the present invention.

Tasks 130 have three different context properties 109, namely links, roles and priorities. The links property 109 is the same as the links property 109 of processes 120, in that it indicates the other components 110 that are linked to the specific instance of the task 130.

The roles property 109 indicates which users are to complete the tasks 130. The present invention does not assign tasks 130 to individual users, but rather to groups of users referred to as roles 270. A server then assigns individual users to one or more roles 270. The roles 270 are selected from a list of all predefined roles 270 in the process model 100.

By default, a task 130 is assigned to all users in a role, and is considered complete when a single user completes the task. It is possible to specify that more than one user must finish the task 130 before the task is complete. It is also possible to control how the task 130 is assigned to users in a role. For instance, tasks 130 can be assigned to a single user following a sequential pattern (first user number 1, then user number 2, etc.). It is also possible to limit the assignment of tasks 130 to roles 270 according to the value of role attributes 108 (described in more detail below). For example, for the role salesperson, a task 130 may only apply to those salespersons who work in the United States.

Multiple roles 270 can be associated with a single task 130. For example, in a customer service department, the “Customer Call Handling” task 130 can have association with two roles 270: “Customer Representatives” and “Customer Representative Supervisor.” By associating this task 130 with these two roles 270, the system will allow both the supervisor and the customer representative to handle customer calls.

Another task distribution option is to assign the task 130 to a person who completed the previous task 130 in the process 120. For example, the business rules may require the Claim Approval task 130 to be performed by the same person who did Claim Review task 130.

The priority property 109 is used at runtime to prioritize the work presented to a given end-user. The priority property 109 may be used simply to sort the list of available tasks 130 presented to the user, or it may be used to automatically select the next task 130 for the user to accomplish.

The priority of a task 130 can be set to a numeric value from 1 (low) to 10 (high). This assignment can be done statically, can be derived dynamically from the context, or inherited from the previous task 130 in the process 120. If the priority is set dynamically, then a priority decision tree through either conditional statements (i.e., if customer=“IBM” then priority=10 else priority=1) or a decision tree similar to the control flow trees described below.

Router 140

Routers 140 are used when designing the control flow of a business process 120. A router 140 will split a control flow into different branches based on a specific condition or decision. Typically the branching takes place based on business data values stored in attributes 108. For example, upon completion of a task 130 such as reviewing a proposal, the control flow can split into three branches based on the result of the proposal review task 130 which could be stored in attribute 108 of the task's result 106:

approve the proposal and initiate the next task 130;

reject and end the proposal activity; or

comment and send the proposal back to its originator for revision.

As shown in FIG. 5, routers 140 have a single default action 104 (start), and multiple, mutually exclusive results 106 (with defaults being branch1 and branch2). The properties 109 of a router 140 are the same as the global properties of processes 120, except that a router 140 does not have an initiate ad hoc property.

Controller 150

A controller 150 has two useful attributes. First, a controller 150 is reusable in other projects. Second, a controller 150 is used as a container 112 of other components 110, especially adapters 240.

As explained below, adapters 240 provide access to business data existing outside the process model 100. Unfortunately, the use of adapters 240 requires programming knowledge. In order to shield the business analysts from having to utilize adapters 240 directly to access business data, programmers embed the adapter 240 in a controller 140. The business analysts can then use the controller 150 to define process models without knowing the underlying technical details of the adapter 240.

Other than the lack of the initiate ad hoc property 109, controllers 150 have the same default events 102 and properties 109 as processes 120, which is shown in FIG. 5.

Elements 160

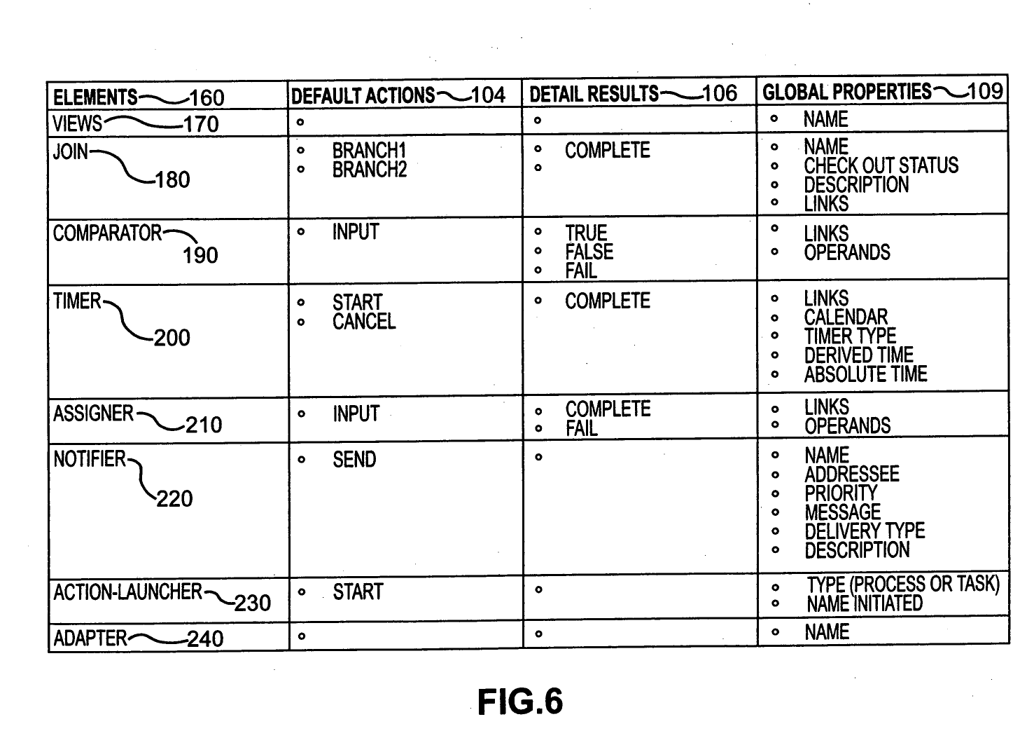

Elements 160 are those portions of a process model 100 that do not contain other components 110. As seen in FIG. 3, the preferred embodiment of the present invention utilizes eight different elements 160, namely views 170, joins 180, comparators 190, timers 200, assigners 210, action-launchers 220, notifiers 230, and adapters 240. FIG. 6 shows each of the elements 160 and their default actions 104, results 106, and global properties 109. Since elements 160 cannot be reused, there are no context properties 109 for elements 160. These elements 160 are described in more detail below.

Views 170

Each task 130 contains the business data, logic, and interface elements necessary for an end-user to complete the task 130. This information is presented to the user through a user interface defined by the views 170 of a task 130. Because the present invention is designed to interact with users through a variety of operating system environments, the views 170 must be created to handle these differing platforms. In the preferred embodiment, supported platform environments include Java, HTML, and the Palm OS. It would be well within the scope of the present invention to support other operating environments.

Since it is necessary to generate separate interfaces for each of these environments, the present invention uses separate views 170 for each environment supported in a task 130. All the views 170 contained within a particular task 130 are collectively referred to as a view set 172. It is possible to define which view 170 will be utilized to complete a task 130 via the role 270 that will receive the task assignment. For example, an end-user performing a purchase order related task in his or her office might use the Java (otherwise known as “Swing”) interface on a desktop computer, whereas a broker on the stock exchange floor may prefer to use a Palm OS interface on a palm computer having a wireless interface.

Each view 170 will contain one or more panels 174, with each panel presenting the end-user with a screen of information. The panels 174 include traditional interface elements such as text, graphics, data fields, buttons, and check boxes. The present invention provides tools for designing such panels 174 graphically, as is described in more detail in connection with the task editor. In order to link GUI panels together and to provide for sophisticated updates of panels 174, the present invention utilizes task controllers 176. Task controllers 176 are associated with one or more panels 174, and used for such management functions as the enabling or disabling of controls on a panel 174, performing data validation, or controlling interaction between multiple panels 174.

Join 180

Joins 180 synchronize multiple processes 120 or tasks 130, requiring that a result 106 from each process 120 or task 130 be received before allowing further processing. As a result, joins 180 are used when two or more parallel processes 120 or tasks 130 come together in a single thread of control. For example, a join 180 could be used to start a process 120 for approving a loan only after all of the preliminary steps have been accomplished.

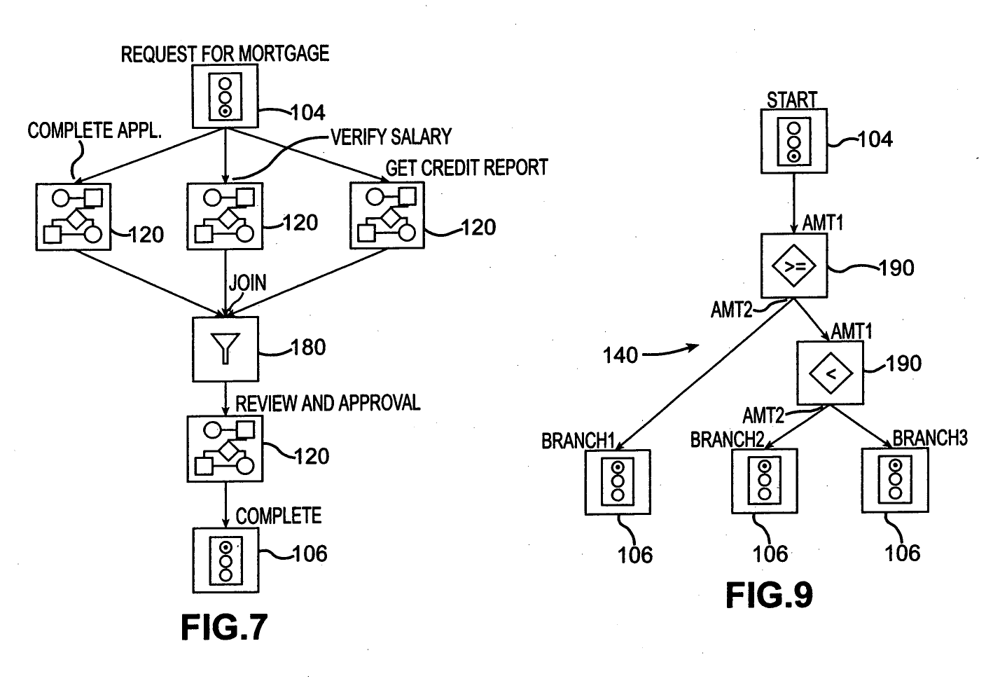

FIG. 7 contains a schematic diagram of a process 120 for accepting a mortgage application that utilizes a join 180 used in this manner. This diagram uses icons similar to the way icons for components 110 are used in the control flow editor 340 described below. In this figure, the action 104, which starts the process for handling a mortgage request, is shown as a stop light icon with the green light lit. This action 104 is used to start three additional processes 120 simultaneously: one for completing the application, one for verifying salary information, and one for obtaining a credit report. Each of these processes 120 is shown with an icon containing a small flow chart. The join element 180 is used to gather the results of these three processes 120, and to prevent the last process 120 (“Review and Approval”) from starting before all three processes 120 have completed. Once this last process 120 is complete, the result “complete” 106 is fired, which is represented by an icon with a stop light lit.

As shown in FIG. 6, joins 180 have multiple input actions 102, predefined as branch1 and branch2, as well as a single default result 106 called complete. The join 180 accomplishes its function by waiting for all actions 104 to be received before firing the complete result 106. The properties 109 for a join 180 shown in FIG. 6, are the same as similarly name properties described in connection with FIG. 5.

Timer 200

Timers 200 are used to control flow in a process model 100 by generating business results 106 after the passage of a time has occurred. Timers 200 can be used to generate alerts, provide built-in delays in processes 120 and tasks 130, and to created deadlines for process 120 and task 130 completion.

When a timer 200 is placed in series within the control flow, the timer 200 acts as a delay element. The flow does not proceed until the configured time period has elapsed. When a timer 200 is placed in parallel with the control flow, the timer 200 can be used to provide notification events if the process 120 or task 130 execution exceeds the configured time period. Care has to be taken when using timers 200 to make sure the timer 200 is cancelled when there is no more need for the notification (i.e., timed processes 120 or tasks 130 have been completed).

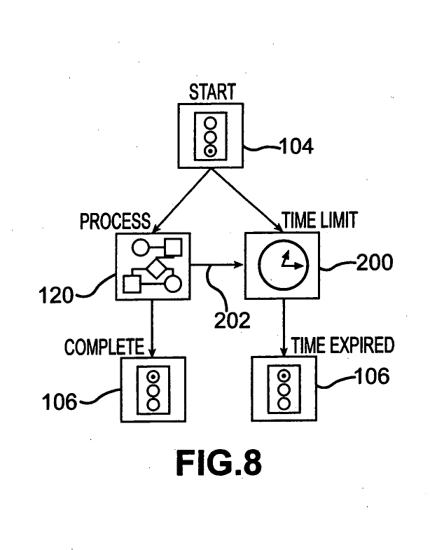

FIG. 8 shows a schematic diagram using a timer 200 in parallel. The timer 200 triggers a time expired result 106 if the time to complete the process 120 exceeds the time limit. Note that both the process 120 and the timer 200 are triggered by the start action 104. When the process 120 completes, the process 120 both triggers a complete result 106 and cancels timer 200 by sending a result 106 (indicated by line 202 on FIG. 8) that is treated by timer 200 as a cancel action 104.

As shown in FIG. 6, timers 200 have two default actions 104: start and cancel. Timers 200 also have a single result 106, namely “complete.” Timers 200 begin running when the start action 104 occurs, and then fire the complete result 106 when the defined time interval is completed. The receipt of a cancel action 104 prior to the expiration of time will prevent the expired event from being fired.

Timers 200 have five properties 109, as shown in FIG. 6. The links property 109 indicates the other components 110 to which the timer 200 is connected. The calendar property 109 indicates which calendar 290 is used to track time. As is explained in more detail below, a calendar 290 is a resource 250 that is used to determine what counts as “countable” work time. For instance, a time of four hours may mean four absolute hours, or may mean four working hours, where working hours are 9 a.m. to 5 p.m., Monday through Friday. The definition for working hours is kept in a calendar 290.

The type property 109 indicates whether the timer utilizes absolute time (Jan. 1, 2003, 4 p.m. Eastern Standard Time), relative time (three hours from the start time), or derived time (the first Tuesday of every other month). Properties 109 also exist for storing the appropriate time data (such as the selected absolute or relative time, or the logic for determining the relative time). This information is stored in the absolute time, relative time, and the derived time properties.

Comparator 190

A comparator 190 compares two values using a set of operators to generate True or False boolean results. Comparators 190 can be used directly in a process 120 when only two results are needed, or can be combined within a router 140 for more complicated decision tree needs.

An example of a router 140 definition utilizing two comparators 190 is shown in FIG. 9. This router is going to compare a certain amount (“Amt1”) to two other amounts (“Amt2” and “Amt3”). If Amt1 is less than Amt2, then result 106 titled Branch1 should be triggered. If Amt1 is more than or equal to Amt2, but less than Amt3, then Branch2 should be triggered. If Amt1 is more than or equal to Amt3, then the result 106 titled Branch3 is triggered.

For numeric attributes, comparators 190 can use the following standard types of comparisons: less than, less than or equal to, equal to, great than, greater than or equal to, not equal. For string attributes, comparators 190 can perform equality (TRUE if the same string) or inequality (TRUE if different strings). Additional operations, such as a text alphabetical less than or greater than, although not incorporated into the preferred embodiment of the present invention, would be obvious to one skilled in the art and are well within the scope of the present invention.

As shown in FIG. 6, comparators 190 have a single action 104, namely input. The input action 104 initiates the comparator 190 and transfers values to be compared to the attributes of the comparator 190. The three possible default results 106 for a comparator 190 are true, false, and fail. Finally, comparators 190 have two additional properties 109: links and operands. The link property 109 indicates the components to which this comparator 190 is connected. The operand property indicates which values are getting operated on. These values can be context data or hard coded values.

Assigner 210

The assigner 210 is used to assign a value to an attribute 108. As shown in FIG. 6, the assigner 210 has a single input action 104. The possible results 106 of an assigner 210 are either complete (indicating successful assignment), or fail (the assignment failed). Like the comparator 190, the assigner 210 has links and operands as its only properties 109.

Action-Launcher 220

The action-launcher element 220 is used within a process 120 or a task 130 to asynchronously start a new process 120 or task 130. The initiated process 120 or task 130 is started outside the context of the process 120 or task 130 in which it was started. This differs from embedded process 120 where the parent process 120 must wait for the embedded process 120 to finish before the parent process 120 can be deemed complete.

The single action 104 of an action-launcher 220 is the start action, used to initiate the new process 120 or task 130. There are no results 106 listed on FIG. 6, since an action-launcher 220 creates an independent process 120 or task 130 and no result 106 will be returned.

The two properties 109 of an action-launcher 220 are type (which indicates whether a process 120 or task 130 is initiated), and name initiated, which identifies the name of the component initiated.

Notifier 230

A notifier 230 is used to provide an asynchronous message to end-user(s) of the occurrence of an event. When the notifier 230 is triggered, a text message is sent to the inbox of addressed users through the process server 500 of the present invention, or alternatively an email message is sent to the specified user's email address. There is no result associated with a notifier, since like an action-launcher 220 a notifier 230 is started outside the context of the current process 120 or task 130.

The single action 104 for a notifier 230 is send, which initiates the message and transfers the relevant attributes to the notifier 230. The name property 109 is the name that appears as the title of the message in the inbox, or as the regarding line in the e-mail. The addressee property 109 can either define the roles 270 or the e-mail addresses that should receive this notification.

The priority property 109 is used only with messages passed through the process server inbox, and is set the same way as priority is set in tasks 130. The message property 109 is the textual body of the message. The delivery type distinguishes between process server messages and e-mails. Finally, the description is textual documentation of the purpose and use of the notifier 230.

Adapter 240

Adapters 240 provide a means to access existing sources of business data or logic, such as existing corporate applications, middleware, and databases. In addition to accessing business data, adapters 240 can be used to initiate an external program, to start a separately defined business process 100, or to access or generate middleware events. It is important to recognize that an adapter 240 does not contain business data or programming logic itself. Rather, the adapter 240 provides an interface to an external source.

To accomplish these varied tasks, adapters 240 encapsulate external data or control in a format usable by processes 120 and tasks 130. Although processes 120 and tasks 130 can utilize adapters 240 directly, adapters 240 are generally incorporated inside controllers 150. This is because the process of encapsulating existing data or control can be complicated. When the adapter 240 is incorporated into a controller 150, these complicated details are hidden and instead the information is presented to the designer of a process model 100 through the simplified interface of the controller 150.

The present invention has a variety of predefined formats for adapters 240. The first format is used to interface with new or existing Java classes. A second format allows adapters 240 to serve as an interface to existing middleware products, such as the Enterprise/Access middleware product from Computer Network Technologies (Minneapolis, Minn.), or the ActiveWorks middleware product from Active Software (Santa Clara, Calif.).

Regardless of the format of the adapter 240, the specific interface of the adapter 240 to the external source is specified in the adapter editor of the present invention. In addition to defining this interface, the adapter editor defines the standard actions 104 and results 106 of the adapter 240. The adapter editor will function similarly to the interface used in prior art middleware products that also serve to integrate disparate business data and logic.

DB Components 242

A DB component 242 is much like an adapter, except that a DB component 242 provides an interface for industry standard database management systems. For instance, DB component 242 could provide an SQL interface to allow queries to any number of databases that support the use of SQL to access and alter data.

BE Factories 244

As described below, business entities 260 are logically structured groups of information. BE factories 244 are elements 160 that allow a task 130 to generate business entities 260 during the performance of a task 130. For instance, a task 130 may be defined to allow a user to enter new claims. A claim would comprise multiple pieces of information that are grouped together into a single business entity 260. The user interface for this task 130 may include a button that the user selects to create a new claim. This button would be associated with a BE factory 244 which creates a new instance of a claim business entity 260.

Lockers 246

Lockers 246 are used to lock or unlock a process 120 using the data in a business entity 260 as a key. For example, a Mail Order process 120 could lock itself using a Customer Order business entity 260 as key after completing the task 130 that sends the customer a bill. Running in parallel with the Mail Order process 120 could be a Payment Received process 120 that receives payments for orders made by customers. The Payment Received process 120 can unlock the Mail Order process 120 using the same Customer Order business entity 260 as key. Once unlocked, the Mail Order process 120 would then resume running and then a execute Ship Order task 130, the next task in its control flow.

Resources 250

Resources 250 are another type of building block used to define a process model 100. Specifically, resources 250 define the basic business data used in the process model 100. In other words, the resources 250 constitute the data structures and instances of these structures that are used to store business information. For instance, when attributes 108 of an event 102, component 110, or element 160 are initially defined, it will be necessary to associate the attribute with a particular type of resource 250. In the present invention, resources 250 include business entities 260, roles 270, users 280, calendars 290, decision criteria 292, and the data controller 294.

Business Entities 260

Business entities 260 are logically grouped pieces of information that represent entities used in a business. The structure of a business entity 260 can be of almost any type that is useful to the designer of the process model 100. Generally, the business entity 260 is defined by creating one or more attributes 108 (the data fields in the data structure), with each attributes 108 being either a standard predefined variable type (such as text/string, integer, long, etc.) or another business entity 260. For example, a business entity 260 could be created for an address consisting of separate attributes 108 (i.e., text fields) for street address, city, state, zip. The address business entity 260 could in turn be an attribute 108 of a different business entity 260 entitled “Customer.” This allows business entities 260 to represent record structures that capture business information in a useful format.

Roles 270

Roles 270 are resources 250 that are predefined to capture an enterprise's job functions. In effect, roles 270 are a predefined business entity 260, with certain mandatory attributes 108 such as role name. The use of roles 270 was described above in the discussion of task 130 assignment. By assigning tasks 130 to roles 270 instead of individual users 280, the present invention allows more flexibility in completing tasks 130. This is especially useful in today's rapidly changing business environment, with high employee turnover and frequent job reassignments.

Roles 270 are flexible enough to allow the designer of a process model 100 to add additional attributes 108 to each role. For instance, a role 270 for “Salesperson” might have the attributes of region, territory, quota, etc. The values of the role attribute can be assigned during deployment or at runtime.

Users 280

Like roles 270, users 280 are predefined business entities 260 with certain mandatory attributes 108. The user 280 resource represents the actual human users who perform tasks 130, define the business model 100, or otherwise interact with the present invention. Users 280 who perform tasks 130 can be assigned multiple roles 270. The definition of a user 280 in the present invention includes mandatory attributes for name, user ID, password, supervisor, and roles 270 to which the user 280 is assigned. Each user 280 can also be assigned to multiple groups 282 of users, such as a group 282 defining male employees or employees that participate in a stock ownership plan. Although users 280 are predefined with these attributes, each enterprise can add more user level attributes that are appropriate for their business.

Calendars 290

Calendars 290 are another type of predefined business entity 260. As mentioned above in connection timers 200, calendars 290 provide a means to define a predetermined set of time. In most enterprises, it is necessary to track time using different calendars, such as work-time, real-time, over-time, etc. The calendar 290 resource allows for such time to be pre-defined according to the practices of a particular enterprise. For instance, a work-time calendar 290 might be defined to include standard work hours and exclude week-ends and holidays. The work-time calendar 290 could then be used to track the passage of time in connection with a timer 200 designed to ensure all orders are shipped with three working days of the order's receipt.

Decision Criteria 292

Decision criteria 292 are specialized business entities 260 used to represent a specific value. Since decision criteria 292 are simply business entities 260, decision criteria can be used in any place that business entity 260 data is used.

Examples of decision criteria 292 include specific dollar limits above which supervisory approval is needed for refunds or claims. Such a dollar limit can be assigned across a whole enterprise, or by division or geographic area. The choice to use decision criteria 292 to represent this dollar limit rather than a business entity 260 is made because the limit is stable and would not vary during run-time like a typical business entity 260. Decision criteria 292 are used in place of hard-coding values into the process model 100 because it may be necessary to change the value at a later date, and it is easier to change decision criteria 292 than locating all instances of a hard-coded value.

Another appropriate use for decision criteria 292 would be a flag that is used to switch to different process models 100 depending on current business conditions. By using such a flag, the process flow of the business can be altered during run-time simply by changing the flag, without a redefinition of the defined control flow.

Data Controller 294

The data controller 294 is a special type of resource 250 and is not merely a specialized type of business entity 260. Rather, the data controller 294 is an object that represents the complete set of business data available to the process model 100, including all the data in business entities 260, as well as the attributes 108 and properties 109 of the task 130 in which the data controller 294 is found. All of this data is brought together in one place in the data controller 294 to help make task 130 definition easier, as explained below in connection with the task editor 380.

Software Tools

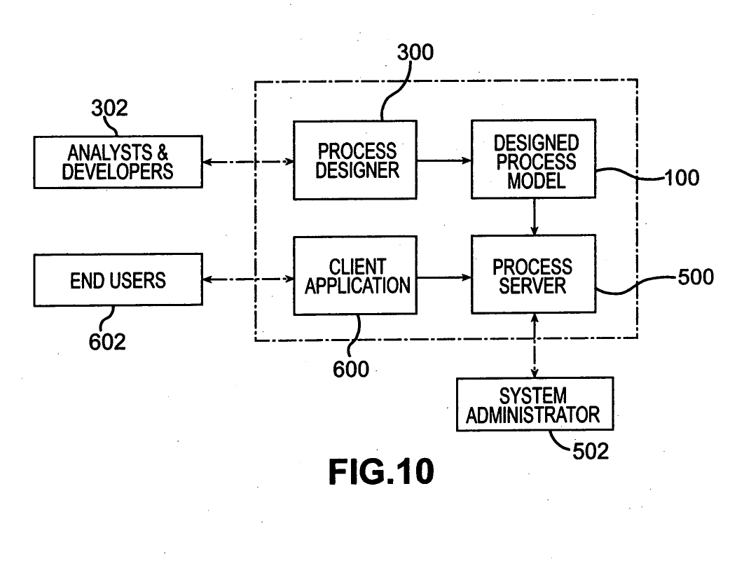

As shown in FIG. 10, the present invention uses three software tools to create and implement process models 100: a process designer 300, a process server 500, and a process client 600. The process designer 300 is the software tool that actually defines the process models 100. Process designer 300 allows users 280 referred to as business analysts, designers, or developers 302 to define a process model 100 for their enterprise. To do this, the process designer 300 gives developers 302 a GUI interface to aid in the development of components 110 and resources 250, and to allow the definition of process and data flow between the components 110. Except for the creation of adapters 240, all of this can be accomplished through the graphical interface of the process designer 300 without having to do any traditional programming.

Upon completion, the enterprise process model 100 is then deployed on the process server 500, which serves as the workflow engine of the present invention. The process server 500 runs the procedures 120 found in the process model 100 and presents tasks 130 to the appropriate roles 270. The process server 500 coordinates the assignment of tasks 130 through the priority properties 109 of the individual tasks 130. The process server 500 also provides management interfaces to give users 280 known as administrators 502 control over business processes 120. Administrators 502 log on directly to the process server 500 to obtain insight into the day to day workings of the enterprise. The prioritization and assignment of tasks 130 can be monitored and adjusted as necessary, with alerts being generated when volume or delay thresholds are exceeded.

The process client 600 is a GUI based application that allows end-users 602 to log on and connect to the process server 500, access the tasks 130 assigned to them, and perform the tasks 130 according to their priority. The end-users 602 automatically get access to the necessary information and resources through the views 170 designed for the task 130.

Process Designer 300

Repository 310

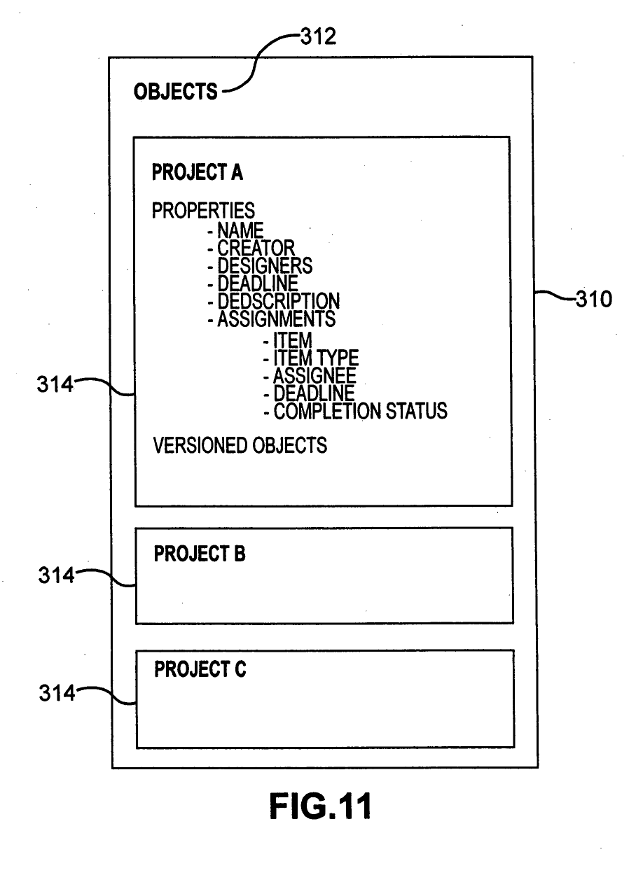

The process designer 300 is where the definition of the process models 100 is accomplished. The process designer 300 allows multiple designers 302 to work in collaboration by storing the objects that make up the process models 100 in a database or object called a repository 310. As shown in FIG. 11, the repository 310 itself contains repository objects 312. The repository objects 312 correspond roughly, but not exactly one-to-one, with the currently defined components 110. This is because the repository contains only objects 312 that can be reused, namely processes 120, tasks 130, and controllers 150, and adapters 240. Containers 112 that cannot be reused (namely routers 140) and elements 160 other than adapters 240 exist in the repository 310 only as objects that are embedded inside other repository objects 312.

The repository 310 is organized into one or more projects 314. The purpose of the projects 314 is to divide the job of creating process models 100 into separate, more manageable undertakings, each with a limited set of designers 302 working on limited goals with a predetermined deadline. Multiple designers 302 can work simultaneously in the same project 314. Repository objects 312 are checked out to a single designer 302 when they are being modified. Other designers 302 working in the same project 312 will not see the modifications until the object 312 is checked back in. If a designer 302 attempts to modify an object 312 checked out by another designer 302, they will be notified that the object 312 is already in use and will be notified as to which designer 302 has the object 312 checked out.

When an object 312 is checked back in, a new version of the object 312 is created. That new version will then be the only version of the object 312 in that project 314. Other projects 314 that utilize the same object 312 will not utilize this new version, but instead will continue use the same version of the object 312 that they were using. In this way, each project 314 has its own version-dependent view of the objects 312 in the repository 310. If a version of an object 312 revised in a different project 314 is desired for the current project 314, that version can be imported into the current project 314.

Projects 314 contain the following attributes 108: name, creator, description, deadline, designers, and assignments. The name, creator, and description attributes 108 record the name, creator, and description of the project 314, respectively. The deadline attribute 108 records the real world deadline for the completion of the project 314. The designers attribute 108 specifies that actual designers 302 that are to work on this project 314. Access to the versioned objects 312 within a project 314 is normally limited to the designers 302 assigned to the project. The assignment attribute 108 assigns to particular designers 302 the versioned objects 312 that make up the project 314. The assignment attribute 108 can also track the deadline by which the objects 312 assigned are to be completed, and whether the objects 312 have in fact been completed.

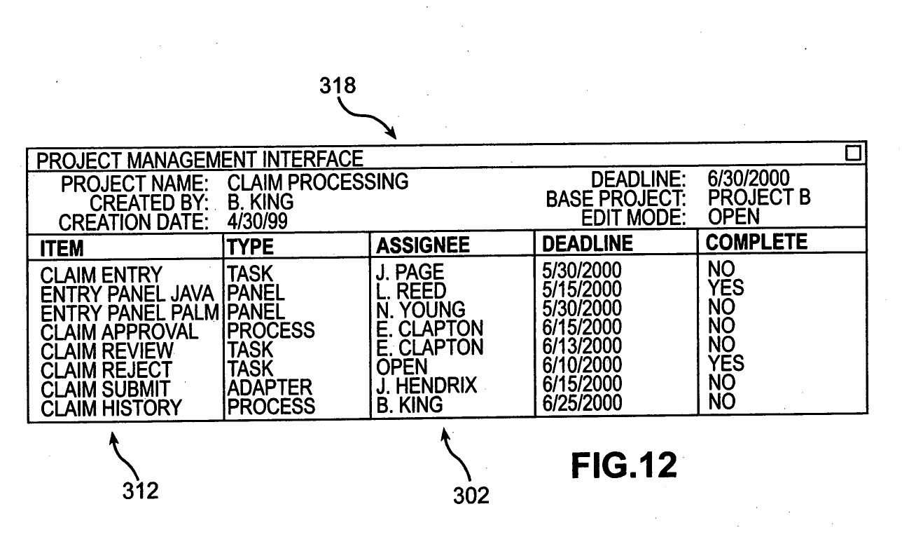

By tracking assignments, it is possible to create a project management interface 318 such as that shown in FIG. 12. Using this project management interface 318, it is possible to track on a single screen all of the objects 312 in a project, the designer 302 to which the objects 312 are assigned, and the deadline date and completion status of the object 312.

User Interface 320

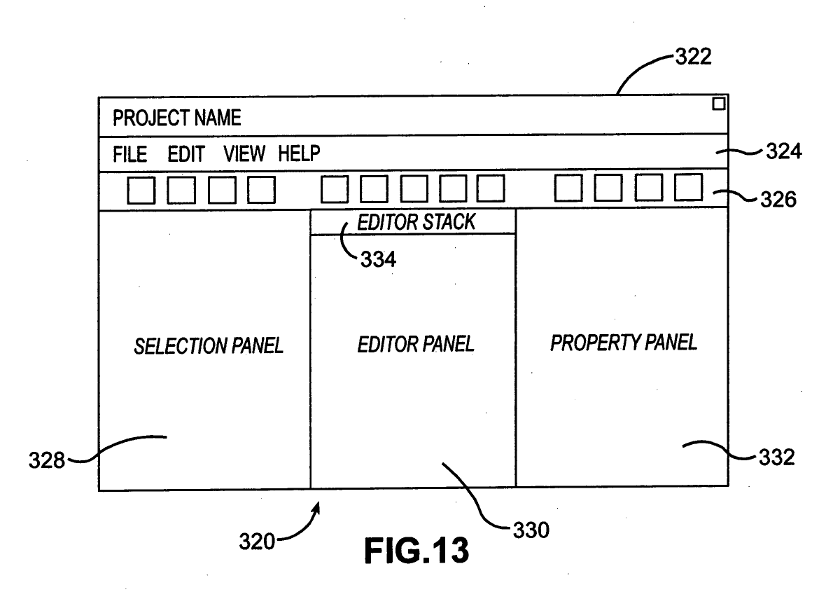

FIG. 13 shows the user interface 320 of the process designer 300. On the top of the interface is the ID banner 322, which contains the name of the project 314 being edited. Underneath the ID banner 322 is the menu bar 324 and the tool bar 326. These bars 324, 326 are standard in interface design, and are used by designers 302 to access program commands in the process designer 300. Program commands are also accessible through pop-up menus and hot-keys, which are also standard in the prior art.

The user interface 320 also contains three panels: the selection panel 328, the editor panel 330 and the property panel 332. These panels can be resized in order to give more or less real estate to the panel of interest. The selection panel 328 lists all repository objects 312 available in this project 314, organized by object type. Visual indicators in the selection panel 328 indicate whether the listed objects 312 have been checked-out, have been altered, and whether the process designer 300 is allowed to edit the object 312. The editor panel 330 is where components 110 are designed. The look and operation of the editor panel 330 will vary depending on the object currently being edited. The property panel 332 displays and allows editing of the properties 109 of the objects 312 selected in the editor panel 330. Tabbed panels can be used to organize the different types of properties 109 for each object type.

Control Flow Editor 340

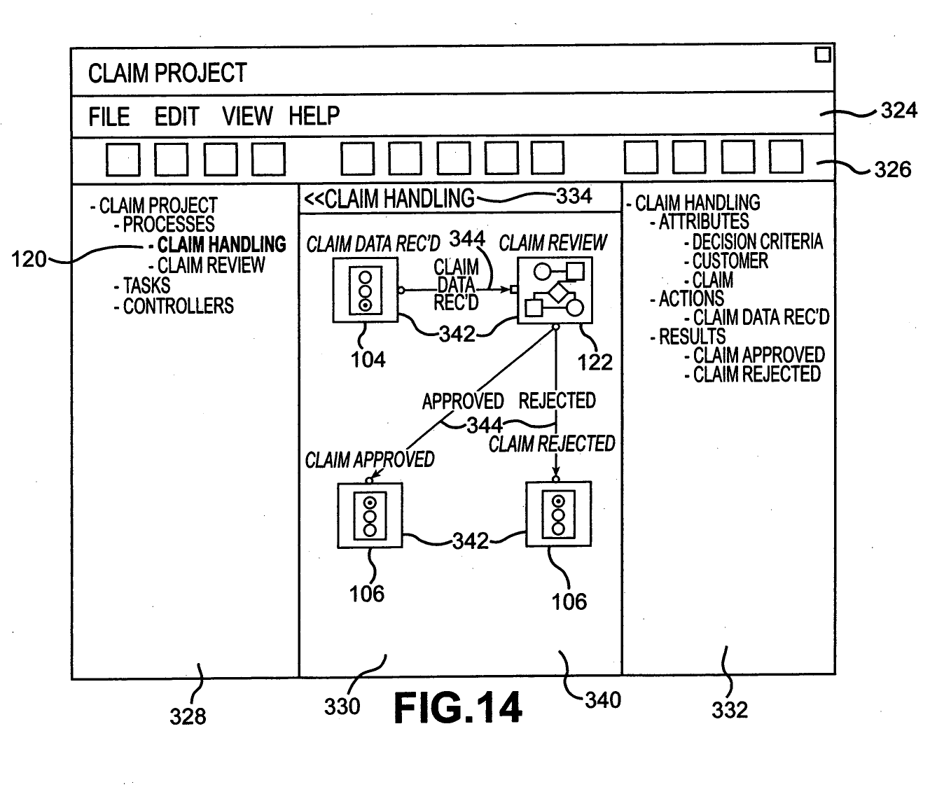

When a process 120, router 140, or controller 150 is being edited through the user interface 320, the editor panel 330 contains the control flow editor 340 shown in FIG. 14. The primary purposes of the control flow editor 340 are to edit control flow, achieve data mapping, and adjust the properties 109 of various components 110.

Editor Elements

While using the control flow editor 340, the designer 302 is able to select repository objects 312 from the selection panel 328, and zoom in and out of individual components 110 in order to edit them. Components 110 can be zoomed into in a variety of ways, such as by double-clicking on an icon representing the component 110. The selection panel 328 does not change when the designer 302 zooms in on a component 110. Instead, the combination of the selected repository object 312 on the selection panel 328 and the editor stack 334 will uniquely identify the component 110 being displayed in the editor panel 330. If a new selection is made from the selection panel 328 directly, then the context of the stack 334 is reset. Because the stack 334 indicates the same as the selection panel 328, it is clear that FIG. 14 shows the definition of the claim handling process 120. If the editor stack showed “<<Claim Handling <<Claim Review,” this would show that the Claim Review subprocess 122 is being edited after being zoomed into from the Claim Handling process 120.

The control flow editor 340 contains icons 342 that represent the multiple components 110 that make up the process 120 being defined. It is important to note that the icons 342 represent not only the components 110 that make up the process 120, but also the events 102 of the process 120 itself. Thus FIG. 14 shows icons 342 for the single action 104 (showing a “go” traffic light), the two results 106 (showing a “stop” traffic light), and the subprocess 122 (showing a small flow chart). Arrows 344 between the icons 342 show the control flow of the process 120. While it is preferred that the icons 342 shown in the editor panel 330 are recognizable and understandable to the designer 302, the actual icons 342 used in the preferred embodiment are not a crucial part of the present invention. Variations of the icons 342 would be well within the scope of the present invention.

Commands

Some of the operations that can be performed within the control flow editor 340 are shown in the following Table 1.

TABLE 1

| Operation | Definition |
|---|---|
| New Component | Add a new component 110 (limited by |
| | hierarchy rules in FIG. 4) |
| Add from repository | Add a re-useable object 312 from the repos- |
| | itory 310 (also limited by hierarchy rules) |
| Step in | If selected component 110 is a container 112, |
| | the editor panel 330 updates to the context |
| | of the selected component 110, with the stack |
| | 334 updated to show the hierarchy context |
| Step Out | Resets the editor panel 330 to the parent |
| | container 112 |
| Checkout | Enables existing component 110 to be edited |
| Check-in | Checks in changes to a modified component 110 |
| Revert | Restores component 110 to version prior to |
| | checkout |
| Assign/Re-Assign | Changes the assignment of the component 110 |
| Component Renaming | Renames component 110 |
| Delete component | Deletes component 110 from context, but (if |
| | re-useable), the component 110 is not deleted |
| | in the repository 310 |
| Define Attributes | Define the attributes 108 of the selected |
| | component 110 |

To define a process 120, a designer 302 would first create some or all of the components 110 of the process 120. New components 110 are created by selecting the command to create the desired component type from the menu bar 324, toolbar 326, or a pop-up menu. Only those components 110 permitted by the component hierarchy shown in FIG. 4 can be created. As each component 110 is created, an icon 342 representing the component 110 is set forth on the editor panel 330. Pre-existing, reusable components 110 can also be added to the definition of the selected process 120 by choosing the component 110 from the repository objects 312 listed on the selection panel 328.

When the claim handling process 120 of FIG. 14 was first created, the control flow editor 340 showed the default action 104 “start” and the default result 106 “complete.” To create the process 120 shown, the designer 302 added a second result 106, and renamed the action 104 and results 106 to “claim data received,” “claim approved,” and “claim rejected,” respectively. The designer 302 then created a new subprocess 122 and named it “claim review.” The designer 302 also defined the “decision criteria,” “customer,” and “claim” attributes 108 of the claim handling process 120, as can be seen by examining the properties panel 332 in FIG. 14. This is accomplished simply by executing the “define attribute” command. The decision criteria attribute 108 is a decision criteria 292 resource, while the customer and claim attributes are defined business entities 260. The customer business entity 260 is made up of data fields and other predefined business entities 260, such as name, customer ID, address, and phone numbers. Similarly, the “claim” business entities 260 may contain fields describing a reason for the claim, the claim amount, and whether the claim was accepted or rejected.

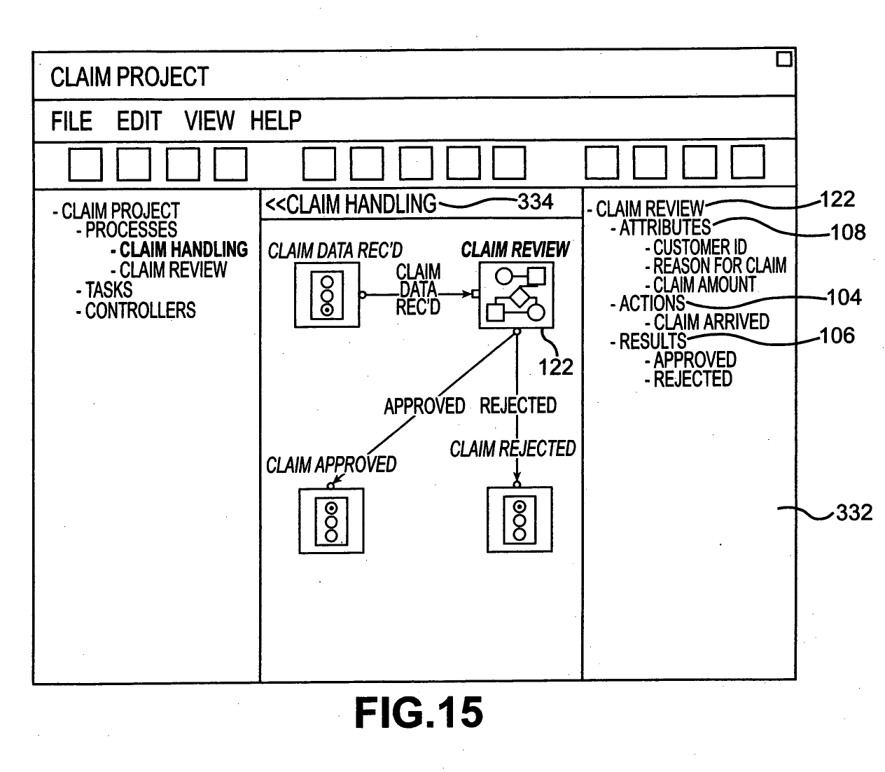

If the Claim Review subprocess 122 is selected without zooming into the subprocesses 122, the subprocess 122 is highlighted and the attributes 108, actions 104, and results 106 of the claim review subprocess 122 are then shown in the property panel 332, as shown in FIG. 15. In this way it is possible to see the attributes 108 and events 102 of a component 110 without changing the context of the stack 334. As seen in this Figure, claim review subprocess 122 has three attributes 108 (“Customer ID,” “Reason for Claim,” and “Claim Amount”), a single action 104 (“claim arrived”), and two results 106 (“approved” and “rejected”). Although it is not shown in FIG. 15, Claim Review subprocess 122 is likely to include a task 130 that allows an user end-user 602 to determine whether the claim should be rejected or accepted.

Control Flow Wiring

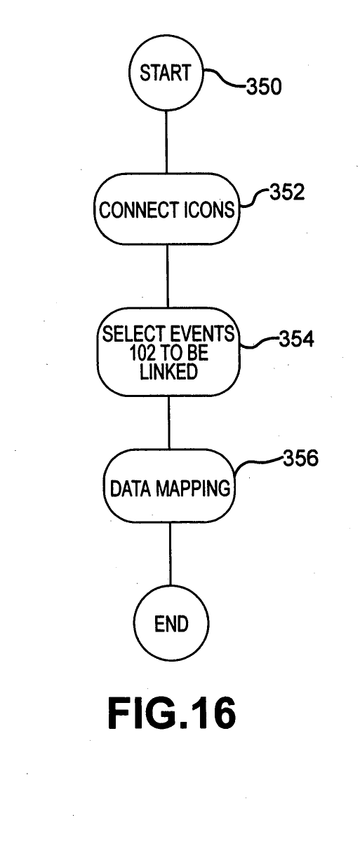

The control flow is created for the claim handling process 120 by “wiring” together the icons on the control flow editor 340. As part of the wiring, the present invention links together a result 106 with an action 104, maps data from the enclosing container 112 to the enclosed component 110, and creates attributes 108 as needed to allow data mapping. These steps are shown in flow chart 350 of FIG. 16.

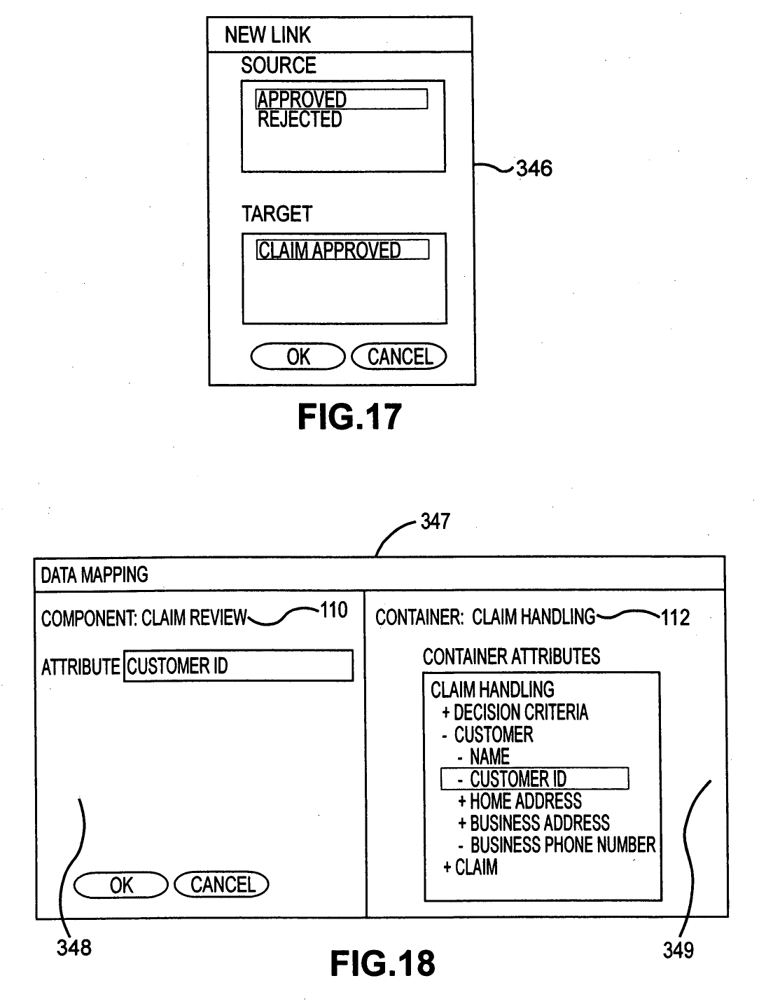

The first step 352 of flow chart 350 is to simply drag the cursor from one icon (the source element) to another icon (the target element), which causes the arrow 344 to be drawn from the source to the target icons 342 on the control flow editor 340. This arrow 344 represents the linking of a result 106 of the source element to an action 104 of the target element. Because the source element may have multiple results 106, and the target element may have multiple actions 104, it is important that the designer be allowed to select the events 102 that are being utilized in this link. This is done in step 354 through a pop-up window presenting the possible events 102 to the user for selection. An example of such a window 346 is shown in FIG. 17. In this case, this window 346 shows the link between the claim review subprocess 122 (having two results 106—accepted and rejected) and the claim approved result 106 of the claim handling process 120. After the designer 302 selects the appropriate events 102 in this window, the arrow 344 between the icons 342 is labeled with the selected result 106 of the source element. Usually, the selected action 104 of the target element is also identified on the control flow editor 340.

Because so much information is conveyed in the graphical interface of the control flow editor 340, a great deal can be learned about the control flow of the claim handling process 120 simply by examining the icons 342 and arrows 344. For instance, in FIG. 14 it is clear that the process 120 being defined has one action 104 and two results 106. The action 104 is named “claim data rec'd,” and triggers the claim review subprocess 122. There are two possible results 106 from this subprocess, namely “approved” or “rejected.” If the approved result 106 is received, then the “claim approved” result 106 of the claim handling process 120 is triggered. If the rejected result 106 is received from the subprocess 122, then the “claim rejected” result 106 is triggered.

It may seem strange that the claim data rec'd action 104 is linked to an action 104 of the claim review subprocess 122. Linking normally takes place between a result 106 and an action 104, not two actions 104. The answer to this conundrum lies in the way the events 102 of the component being defined are treated in the control flow editor 340. Although the actions 104 and the results 106 are not technically components 110 of the claim handling process 120, they are treated as such in the control flow editor 340 for the purposes of control flow wiring and data mapping. For example, the claim data rec'd action 104 is treated as if it were a contained component 110 having a single event 102, namely a result 106 named “claim data rec'd.” Although it seems unusual that an action 104 is treated as a component having only a result 106, this is required so that the “result” of the claim data rec'd action 104 will link with the claim received action 104 of the claim review subprocess 122. Similarly, the claim approved result 106 and the claim rejected result 106 are treated as contained components 110 each having only a single event 102, namely an action 104 with the same name.

Data Mapping

Data mapping is the final step 356 of the procedure described in FIG. 16, after which the procedure ends at step 358. Data mapping is defined as the assignment of the attributes 108 of a contained component 110 to the attributes 108 of the container 112 in which the component 110 is contained. As shown in FIG. 15, the claim review subprocess 122 is contained within claiming handling process 120. Thus, data mapping can be accomplished in that example by mapping the attributes 108 of the claim review subprocess 122 to the attributes 108 of the claim handling process 120 (namely “decision criteria,” “customer,” and “claim” as shown in FIG. 14).

Typically, this mapping is done by simply double-clicking on one of the actions of the contained component 110, such as the “Customer ID” attribute 108 of the Claim Review subprocess 122 shown in FIG. 15. This opens up a data mapping window 347, such as that shown in FIG. 18. The left side 348 of window 347 identifies the attribute 108 currently being mapped as the “Customer ID” attribute 108 of the Claim Review subprocess 122. Although it is not shown in FIG. 18, it would be possible to allow the user to select from all of the attributes 108 of the component 110 shown on left side 348 (the component 110 currently being mapped), such as through the use of a drop down menu or other user interface device.

The right side 349 lists the attributes of the container 112 that contains the component 110 being mapped, namely the Claim Handling process 120. In this example, the three attributes 108 of the Claim Handling process 120 are the Decision Criteria, Customer, and Claim attributes 108. Note that the Customer attribute 108 is a defined business entity 260 structure, made up of a Name, Customer ID, Home Address, Business Address, and Business Phone Number. Selecting an attribute 108 from the right sides 349 and hitting the OK button maps the data between the attributes 108 of the component 110 and the container 112 containing the component 110. In FIG. 18, the Customer ID attribute 108 of the Claim Review subprocess 122 will be mapped to the Customer ID field of the Customer attribute 108 of the Claim Handling process 120.

Of course, other methods and user interfaces may be used to complete the mapping of attributes 108 between components 110 and the containers 112 that contain them and still be within the scope of the present invention. For instance, rather than directly associating the attributes 108 of components 110 and containers 112, it would be possible to assign attributes 108 to events 102. In this case, the attributes 108 of a first component 110 could be passed to a second component 110 by assigning the attributes 108 of the first component 110 to the attributes 108 of the events 102 that link the first component 110 to the second component 110. Arguable, the passing of component attributes 108 through the attributes 108 of events 102 is a cleaner approach theoretically, since both data mapping and control flow would then occur exclusively through the use of events 102. However, in practice, end users tend to prefer the simpler approach of directly assigning attributes 108 of a component 110 to the attributes 108 of its container 112.

Task Editor 380

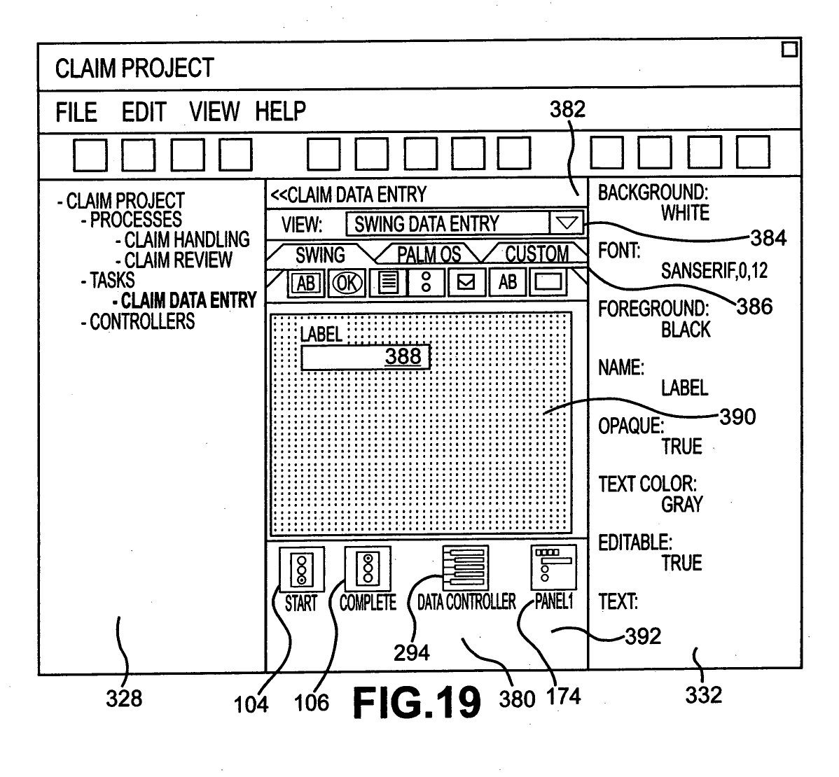

When a task 130 is being edited, the editor panel 330 enters the task editor mode 380, as shown in FIG. 19. Tasks 130 are edited by selecting a task 130 from the selection panel 328, or by zooming into a task 130 in control flow editor mode 340. The editing of a task 130 is more complex than editing a process 120, since defining a task 130 often requires the definition of a user interface and the use of external business data and logic. Consequently, the task editor 380 provides the designer 302 with the means to graphically build user interfaces without programming. The task editor 380 also connects user interface components with data resources 250, and incorporates additional business logic or integration with an external system through the use of adapters 240 and controllers 150.

The task editor 380 contains the editor stack 382, a view selection interface 384, a panel component selection area 386, a panel design area 390, and the object well 392. The editor stack 382 of the task editor 380 functions the same as the editor stack 334 of the control flow editor 340. The view selection interface 384 allows the designer 302 to select the view 170 currently being edited. As explained above, each task 130 has a view set 172 containing all of the views 170 for that task 130, with each view 170 working only with a single operating environment and being composed of one or more panels 174. The panel component selection area 386 of the task editor 380 allows individual GUI components 388 (such as text fields, radio buttons, check boxes, etc.) to be selected for the current panel 174. In FIG. 19, only the Swing (or Java) components 388 are visible, indicating that the current view 170 operates with Java. The panel design area 390 is where the designer 302 combines components 388 selected from component selection area 386 into a panel 174 for use by an end-user 602.

The object well 392 contains the data controller 294. As explained above, the data controller 294 represents all the data available for data wiring with the panel components. Specifically, the data controller 294 will contain the attributes 108 of the task 130 being defined, as well as global data that is accessed through adapters 240 and controllers 150. In addition to the data controller 294, the object well 392 includes all of the actions 104 and results 106 defined for the task 130, as well as panels 174, task controllers 176, controllers 150, notifiers 230, and adapters 240 that have been defined for the task 130.

In some ways, the process of defining a task 130 is similar to defining a process 120. The task 130 can be created within the process 120 that contains it through the control flow editor 340. By selecting the task 130 in the control flow editor without “zooming” into it, the actions 104, results 106, and attributes 108 of the task 130 can be defined in the properties panel 332 of the control flow editor 340. The task 130 can also be linked with other components 110 within the process 120 as described above. Data can also be mapped from the attributes 108 of the process 120 to the attributes 108 of the task events 102.

When a task 130 is zoomed into from the control flow editor 340 or selected from the selection panel 328, the task editor 380 is initiated. The task editor 380 is then used to create views 170, to design the panels 174 and task controllers 176 for the views 170, and perform the data wiring necessary to link panel components 388 with real business data and task events 102. The property panel 332 is used to assign values to the properties 109 of the task 130 itself as well as the properties 109 of the objects used to define the task 130, such as components 388, panels 174, or views 170.

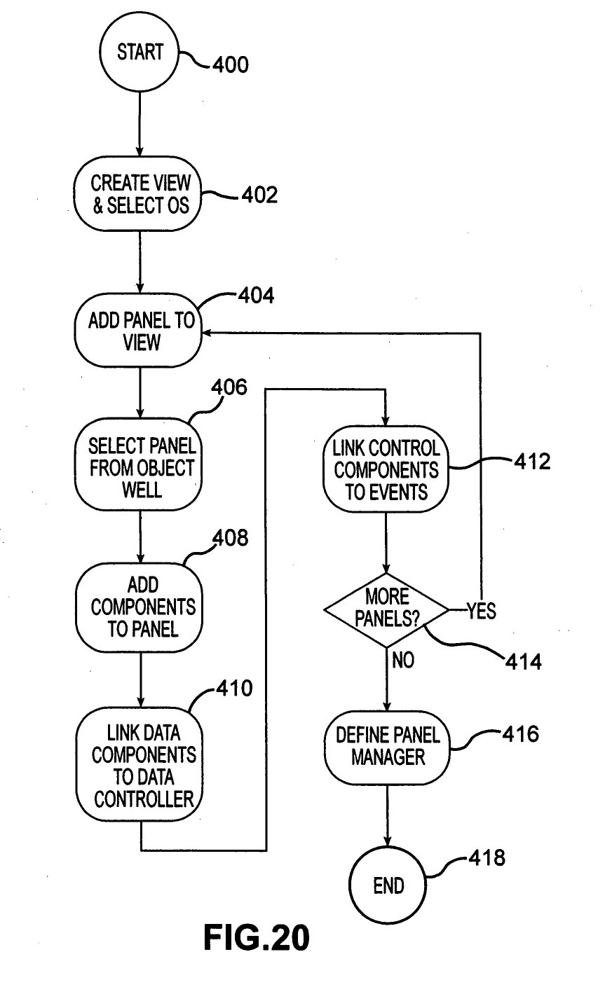

The process for creating a view 170 and its panels 174 for a task 130 is shown in flow chart 400 on FIG. 20. To create a new view 170, the designer 302 simply selects a command to create a new view 170 which requires the designer 302 to select the operating system for this view 170 (step 402). The designer 302 then creates a new panel 174 for this view 170, such as by selecting a “new panel” command, as shown in step 404. Once the panel 174 is created, it is added to the object well 392 for that view 170.

To edit the panel 174, the panel 174 is selected from the object well 392 (step 406). The designer 302 then selects panel components 388 from the panel component selection area 386 and arranges the components graphically on the panel design area 390. The attributes 108 of the various panel components 388 are defined by selecting the component 388 and changing the attributes that appear on the property panel 332 (step 408).

Once these components 388 are arranged into a panel 174 suitable for interaction with an end-user 602, it is necessary to relate (or “wire”) the data related components 388 with the resources 250 in the present invention. This data wiring is accomplished in step 410 by selecting the data controller 294 from the object well 392 and dragging the cursor to the data component 388 being wired. A window opens which allows the data component 388 to be associated with any attribute 108 or external data defined in the data controller 294. Once wired, the data component 388 will be directly related to the data in the data controller 294, allowing the display and updating of external data by end users 602. It is for ease in making this type of wiring of panel components 388 that the data controller 294 was created.

After data components 388 are wired, it is still necessary to give meaning to the control oriented components 388 on the panel 174, such as performing a particular result 106 when the “submit” or “OK” button is pushed. It is also necessary to link the actions 104 to the panels 174 so that a particular panel 174 is opened and displayed to the end-user 602 on the occurrence of the action 104. These requirements are accomplished in step 412. Since the object well 392 shows the current task's actions 104 as well as the current view's panels 174, the act of linking actions 104 to panels is straightforward. All that is necessary is to click on an action 104 and dragging the cursor to the desired start-up panels 174. Once this is done, a window opens to allow the designer 302 to choose whether the action 104 will cause the panel 174 to be shown or hidden. To link a button or other panel component 388 to a result 106, the designer 302 simply selects the component 388 on the panel design area 390 and drags the cursor to the desired result 106. A pop-up window then confirms the desired link between the component 388 and the result 106.

It may also be necessary to allow a control oriented component 388 to create a new instance of a business entity 260. To do so, an object called a BE factory is created in the object well 392 and associated with a business entity 260. The BE factory is then wired to a control component 388, so that when the end user selects the control component 388 (such as by pushing a button component 388 on the panel 174), a new instance of the business entity 260 is created.

If a designer 302 wishes to user multiple panels 174 in a view, step 414 returns control to step 404 to add the additional panel. If no more panels 174 are desired, the user is given the option to create a task controller 176. Task controllers 176 are objects used to help coordinate the various panels 174 created for a particular view 170. To create a task controller 176, the designer 302 utilizes a command that creates a new task controller 176 in step 416. Once created, the task controller 176 appears in the object well 392 of the GUI design panel. A designer 302 can add as many task controllers 176 as necessary.

Task controllers 176 allow a user to create a multiple panel view 170 and to generally coordinate higher level interactivity in the panels 174. The elements and steps necessary to create multiple panel interfaces or high level interactivity are well known in the prior art. The only unique element of task controllers 176 in the present invention is the utilization of events 102 and attributes 108 in the task controllers 176. By giving task controllers 176 events 102 and attributes 108, the task controllers 176 can easily be linked into the control flow and data mapping schemas of the present invention.

Once the task controller is defined in step 416, the procedure for creating a view 170 is complete at step 418. Of course, the steps for creating a view 416 do not need to be followed in this linear matter. In fact, it is expected that a designer 302 will go back to a view 170 definition and make updates to the panels 174, task controllers 176, and the data wiring whenever such changes are desired.

Note that the above description of the task editor 380 assumed that some interaction with an end-user 602 was necessary to complete the task. It is possible to use middleware adapters 240 to simply launch an external application to complete a task 130. In such a case, it would not be necessary to create any views 170, panels 174, or task controllers 176. All that would be necessary is to create the appropriate adapter 240, and link and data map the events 102 of the adapter to the events 102 of the task 130. In this way, control flow is passed to the external application, and data can flow between the process model 100 and the external application.

Process Servers 500

When the process model 100 has been defined, the process designer 300 generates a deployment package and installs it on a process server 500. The deployment package contains all the necessary information to execute the run time application, including the compiled process model 100, related classes and objects, and middleware adapters 240. The deployment package also verifies the consistency and completeness of process 120 definitions, and the check-in status of repository objects 312.

The installation of an updated process model deployment package can be carried out while the servers 500 are up and running. This mechanism allows overlaying an updated or a new process model 100 on the running servers 500 in real-time. While an updated process model 100 is being deployed, tasks 130 already in progress can be carried out according the old definition of the task 130.

Once the deployment package is installed on the process server 500, the runtime system of the process server 500 takes over. The runtime system interprets process data contained in run-time models, reacts to process inputs and dispatches task assignments to be picked up by the end-users 602. The runtime system also maintains information about users and groups, authenticates users that log in to the process server 500, and maintains the access control policies of the server 500. This information is controlled and managed by one or more system administrators 502 through a user manager application running on the process server 500.

The process server 500 must maintain the status of each process 120 and task 130. Each process 120 can be in one of the following states: inactive, active, suspended, complete, or terminated. Tasks 130 are assigned to roles 270 as determined by the roles property 109 in the task 130. When there's a task 130 ready for assignment, it is put into the queue for each role 270 that can handle the task 130. Process clients 600 then fetch tasks 130 from the queues for execution. As described above, it is possible to define the number and distribution of end-users 602 that must complete the assigned task 130 before it is considered complete. The process server 500 tracks the completion status of tasks 130 it assigns to end-users 602 in order to know when the task 130 is considered complete. When the right number is reached, the task 130 is no longer presented to process clients 600 for completion.

Process Clients 600

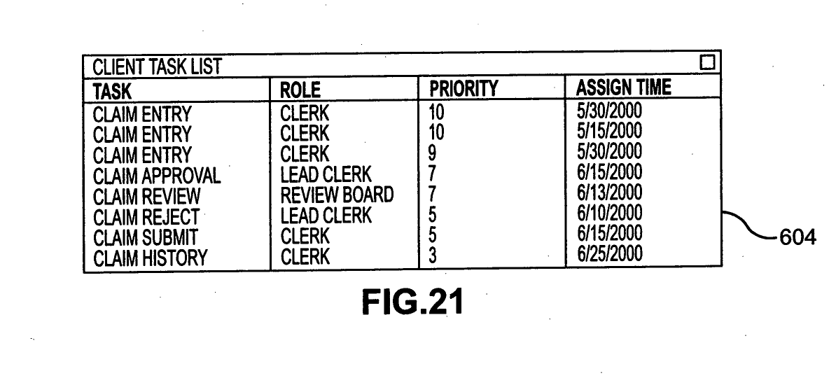

The process client 600 is the front-end application for end-users 602 to log into the process server 500 and view, fetch, and execute tasks. Once connected to a process server 500, the process client 600 is notified of available tasks on the process server queues based on the roles and attributes of logged in user 602. These tasks 130 are presented in the form of a task list 604, as shown in FIG. 21. The task list 604 shows name of the task 130, roles 270, priority, and assignment time.

Tasks 130 in the task list 604 can be accepted, returned, completed, or aborted. When a task 130 is accepted, the process server 500 logs the assignment, and notifies other users 602 in the same role 270 of the assignment. The task 130 is not removed from the queue of tasks 130 at the process server 500 at this time, since an end-user 602 that has accepted a task 130 can return the task 130 to the process server 500 uncompleted. If a task 130 has been returned in this matter, the process server 500 removes the assignment and makes the task 130 available again to all users 602 in the assigned roles 270. When a user 602 completes a task 130, the process server 500 will remove the task 130 from its queue of incomplete tasks 130.

It is also possible for the system administrator 502 to abort a task 130 after it has been assigned. When a task 130 is aborted, the process server 500 removes the task 130 from the queue.

The invention is not to be taken as limited to all of the details thereof as modifications and variations thereof may be made without departing from the spirit or scope of the invention. For instance, it is possible to implement the process models 100 of the present invention using additional or fewer components 100. It would also be well within the scope of the present invention to have views 170 that support only one operating environment, or to assign tasks 130 directly to users 280 as opposed to roles 270. Many possible combinations of features and elements are possible within the scope of the present invention, and therefore the scope thereof should be limited only by the following claims.

1. A method for graphically defining business processes and directly implementing the graphically defined business processes to a level of detail enabling immediate and automatic execution of the business processes by a computer system, comprising:
a) adding components to a process definition, including at least one task requiring user interaction, the task comprising a unit of work performed by a computer program;
b) defining interface elements for the task as events with defined data structures;
c) defining control flow between the components of the process definition;
d) defining data transformation between the control flow and individual tasks;
e) submitting the process definition to a process server for execution of the control flow and submission of the at least one task for end users via the defined interface elements.

2. The method of claim 1, further comprising:
f) defining data flow between components of the process definition.

3. The method of claim 2, wherein at least some of the components have events which can be either an action or a result, and further wherein control flow is defined at least in part by linking a result of one component to an action of a second component.

4. The method of claim 3, wherein certain components are contained within other components.

5. The method of claim 4, wherein the components have attributes.

6. The method of claim 5, wherein the process of defining data flow comprises the associating of the attributes of a component containing another component with the attributes of the contained component.

7. A method of graphically generating an enterprise application and directly implementing the graphically generated enterprise application to a level of detail enabling immediate and automatic execution of business processes by a computer system, comprising the steps of:
(a) identifying a plurality of building blocks that define a workflow process, each building block being representative of a step in the workflow process;
(b) sequencing and connecting together the plurality of building blocks to create a workflow process model;
(c) defining at least one task to be accomplished within at least one of the building blocks, the task comprising a unit of work performed by a computer program;
(d) associating data with the at least one task;
(e) loading the workflow process model on a process server; and
(f) generating on the process server a client application accessible to users.

8. The method of claim 7, wherein each building block is comprised of at least one of a component and resource.

9. The method of claim 8, wherein the component is comprised of at least one of a container and an element.

10. The method of claim 9, wherein the container is comprised of at least one of a process, a task, a router and a controller.

11. The method of claim 9, wherein the element is comprised of at least one of a view, a join, a comparator, a timer, an assigner, a notifier, an action-launcher, an adapter and a locker.

12. The method of claim 8, wherein the resource is comprised of at least one of a business entity, a role, a user, a calendar, a decision criteria and a data controller.

13. The method of claim 7, wherein step (b) comprises graphically displaying the building blocks.

14. The method of claim 7, wherein the task comprises a unit of work performed by a computer program.

15. A method of graphically defining a top-down workflow process and directly implementing the graphically defined top-down workflow process to a level of detail enabling immediate and automatic execution of the process by a computer system, comprising the steps of:
(a) identifying top level process steps in the workflow process;
(b) selecting graphically displayed building blocks to represent each of the top level process steps;
(c) arranging and connecting the building blocks to create a top level workflow process model;
(d) determining which of the top level process steps in the top level workflow process model are amenable to sub-process steps;
(e) for each top level process step identified in step (d), selecting further building blocks to represent the sub-process steps and associating the thus selected building blocks with the respective top level process step identified in step (d);
(f) associating non-control data with at least a portion of the building blocks;
(g) loading the building blocks and at least a portion of the non-control data on a process server; and
(h) running the top level workflow process model using a computer, including any associated sub-process steps.

16. The method of claim 15, wherein each building block is comprised of at least one of a component and resource.

17. The method of claim 16, wherein the component is comprised of at least one of a container and an element.

18. The method of claim 16, wherein the container is comprised of at least one of a process, a task, a router and a controller.

19. The method of claim 17, wherein the element is comprised of at least one of a view, a join, a comparator, a timer, an assigner, a notifier, an action-launcher, an adapter and a locker.

20. The method of claim 16, wherein the resource is comprised of at least one of a business entity, a role, a user, a calendar, a decision criteria and a data controller.

21. The method of claim 15, wherein the building blocks are graphically wired together.

22. The method of claim 15, wherein step (f) comprises mapping data.

23. The method of claim 15, further comprising modifying sub-process steps within a connected building block.

24. The method of claim 15, further comprising making the building blocks available to users via a process design server.

25. The method of claim 15, further comprising requesting a person having particular knowledge about one or more of the sub-processes to assist in selecting and arranging building blocks representative thereof.

26. A system for graphically designing a business process and directly implementing the graphically designed business process, comprising:
(a) a process designer tool having a graphical interface for defining a business process model in a top-down method, the business process model having
(i) at least one process having control flow defined between at least two components, and
(ii) at least one task having a definition, each task definition incorporating a user interface for performing the task and defining access to business data in the form of structured events required to complete the task, the task comprising a unit of work performed by a computer program; and
(b) a process server capable of deploying and executing the process model by following the control flow defined in the process, transferring and transforming data between the process and process components and presenting to at least one end user the defined task via the user interface.

27. A system for graphically creating a process model and directly implementing the graphically created process model for an enterprise, comprising:
a process designer comprising a graphical user interface used to develop components and resources and to define process flow and data flow among said components and resources, the process designer being capable of defining at least one procedure associated with at least one of said components and resources;
a process server for running the at least one procedure and for assigning tasks in accordance with a priority scheme defined in the process designer, the task comprising a unit of work performed by a computer program; and
a process client comprising a graphical user interface operable to allow end users to log on and connect to the process server, to access any assigned tasks and to perform said assigned tasks.

28. The system of claim 27, wherein the process designer presents a plurality of building blocks to a user.

29. The system of claim 27, further comprising a system administrator in communication with the process server.

30. The system of claim 27, wherein the assigned tasks are performed by a computer.

31. The system of claim 27, wherein the process designer makes developed components and resources available for use in other process models.

32. The system of claim 27, further comprising means for defining a common user interface among the components and resources.

33. The system of claim 27, further comprising means for mapping data between components, between resources and between components and resources.
